(19) United States
(12) Patent Application Publication
(10) Pub. No.: US 2025/0157762 A1
(43) Pub. Date: May 15, 2025

(54) UNIVERSAL TOUCH CONTROL REED SWITCH

(71) Applicant: JASON LING, SHENZHEN, GUANGDONG (CN)

(72) Inventor: JASON LING, SHENZHEN, GUANGDONG (CN)

(21) Appl. No.: 18/722,600

(22) PCT Filed: Sep. 17, 2022
(86) PCT No.: PCT/CN2022/119487

§ 371 Date: Jun. 21, 2024

(30) Foreign Application Priority Data
Feb. 8, 2022 (CN) 202210119911.0

(51) Int. Cl. H01H 36/00

(52) U.S. Cl. CPC H01H 36/0006

(57) ABSTRACT

A universal touch control reed switch is provided, including a first lead (3), a second lead (2) and contacts respectively arranged on the first lead (3) and the second lead (2). The contacts are conducted in a touch control mode by using a universal touch control structure. When an external magnet approaches the two contacts in any direction, the two contacts are in contact with each other and closed in any direction through the universal touch control structure. The reed switch provided by the present disclosure uses the special universal touch control structure such that the external magnet, when moving close to the contacts, can close the two contacts regardless of the approaching direction, and a problem of contact failure in the prior art is effectively solved.

FIELD OF THE DISCLOSURE

The present disclosure relates to an electronic component, specifically to a universal touch control reed switch.

### BACKGROUND OF THE DISCLOSURE

A reed switch, also known as a dry reed tube, is a passive electronic switch component with contacts and has advantages such as simple structure, compact size, and easy control. Its shell is typically a sealed glass tube including two iron elastic reed contacts, and is filled with an inert gas called rhodium metal.

The reed switch is also known as a magnetically controlled tube. The reed switch is similar to a Hall element, but based on different principles. The reed switch is a switch controlled by a magnetic field signal, which is non- conductive in the absence of magnetism. The reed switch can be used to detect the state of a circuit or mechanical movement.

The Reed switch usually includes two or three contacts made of materials that conduct both magnetism and electricity, and sealed within a glass tube filled with an inert gas (such as nitrogen and helium) or vacuum. The contacts are arranged parallel in the glass tube, overlapping at the ends with a gap between them or touching to form normally open or normally closed contacts. The Reed switch has a simpler structure, smaller size, higher speed, and longer working life than the regular mechanical switch. Compared to the electronic switch, the reed switch also has strong resistance to load impacts and high operational reliability.

However, conventional structure of the reed switch has some defects. As shown in FIG. 1, when a magnet approaches from above or below, the contacts close accurately, but when the magnet approaches from the side, they may fail to close, causing a malfunction. After being installed in a product, it is impossible to guarantee the magnet will always approach from above or below, making failures unavoidable.

### SUMMARY OF THE DISCLOSURE

The present disclosure aims to solve these technical problems by providing a universal touch control reed switch with a special universal touch structure, allowing a magnet to approach from any direction and solving the contact failure issue.

The present disclosure is realized through the following technical solution: A universal touch control reed switch is provided, including a first lead, a second lead, and contacts respectively arranged on the first lead and second lead. The contacts are conducted in a touch control mode by using a universal touch control structure. When an external magnet approaches the contacts from any direction, the contacts close through the universal touch control structure.

In a preferred embodiment, the universal touch control structure includes an active contact and a ring contact. One end of the active contact connects to the first lead and one end of the ring contact connects to the second lead, or the one end of the active contact is connected to the second lead and the one end of the ring contact is connected to the first lead.

In another preferred embodiment, the active contact and the ring contact are correspondingly arranged in a sealed housing filled with inert gas or vacuum.

In another preferred embodiment, the ring contact has a contact chamber that accommodates the active contact. The active contact is arranged in the contact chamber, and the active contact and the ring contact are in a normally open state. When the external magnet approaches, the active contact and the ring contact are in contact with each other and closed.

The benefits of the present disclosure are that the present disclosure employs the universal contact structure, which ensures that when the external magnet approaches the two contacts, it can trigger the closure of the two contacts from any direction and prevent situations where the contacts fail to close, thereby reducing failure rate.

### BRIEF DESCRIPTION OF THE DRAWINGS

To better illustrate the embodiments of the present disclosure or the prior art, the following figures are introduced. It will be apparent that the accompanying figures in the following description are only certain embodiments of the present disclosure, and those skilled in the art can derive other figures without creative effort.

FIG. 1 is a schematic structural diagram of contacts in prior art.

FIG. 2 is a schematic exploded view of the present disclosure.

FIG. 3 is a schematic assembly view of the present disclosure.

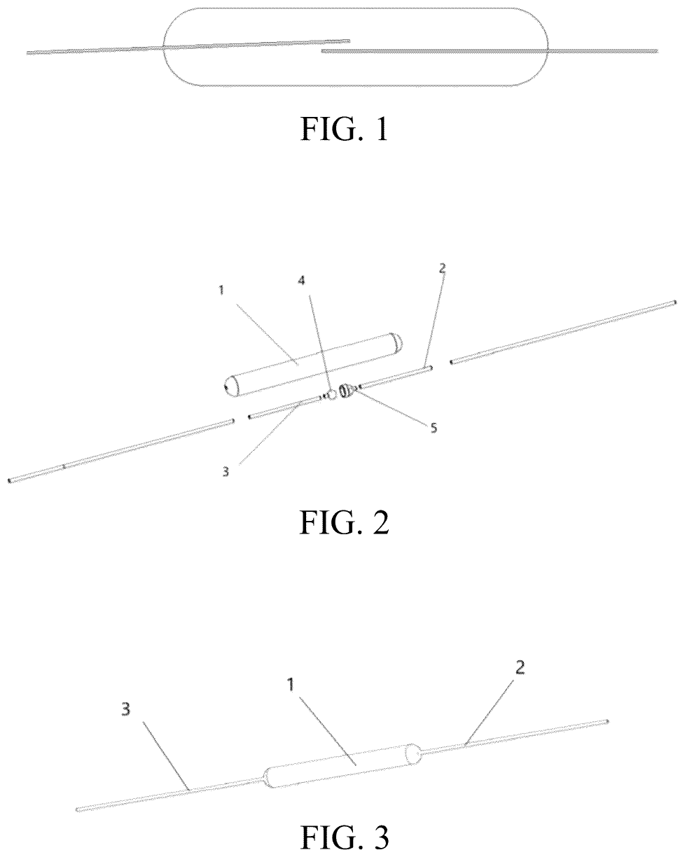

### DETAILED DESCRIPTION OF THE EXEMPLARY EMBODIMENTS

All features disclosed in this specification, or all steps in the methods or processes disclosed, except mutually exclusive features and/or steps, can be combined in any way.

Any feature disclosed in this specification (including any accompanying claims, abstract, and figures), unless specifically stated otherwise, can be replaced by other equivalent or alternative features serving similar purposes. That is, unless specifically stated otherwise, each feature is only an example of a series of equivalent or similar features.

In the description of the present disclosure, it is to be understood that terms indicating directions or positional relationships such as “one end,” “another end,” “outside,” “upper,” “inside,” “horizontal,” “coaxial,” “central,” “end,” “length,” “outer end,” etc., are based on the directions or positions shown in the figures. These are solely for facilitating the description and simplifying it, not to indicate or imply that the referred-to device or component must have a specific orientation or be constructed and operate in a specific orientation. Therefore, they should not be interpreted as limiting the present disclosure.

Additionally, in the description of the present disclosure, “multiple” means at least two, such as two and three, unless otherwise specifically limited.

Terms such as “upper,” “above,” “lower,” “below,” and the like are used to describe the relative spatial relationship of one unit or feature to another, as shown in the figures, for illustration purposes. These terms of relative spatial position may also include different orientations from those shown in the figures when the device is in use or operation. For example, if the device shown in the figures is turned upside down, the unit or feature described as being “below” or “under” another unit will then be “above.” Thus, exemplary terms such as “below” can encompass both above and below. The device can also be oriented in other ways (rotated 90 degrees or otherwise) and corresponding spatial descriptions interpreted accordingly.

In the present disclosure, unless otherwise specified and limited, terms such as “set,” “sleeve,” “connect,” “penetrate,” “insert,” etc., should be understood broadly. For example, they can be fixed or detachable connections, or be integral; they can be mechanical or electrical connections; they can be directly connected or indirectly connected through an intermediary, or they can be interactions between two elements or communications within two elements, unless otherwise specified. Those skilled in the field can understand the specific meanings of these terms in the present disclosure according to specific situations.

As shown in FIG. 2, a universal touch control reed switch of the present disclosure includes a first lead 3, a second lead 2, and contacts respectively arranged on the first lead 3 and the second lead 2. The contacts are conducted by using a universal touch control structure. When an external magnet approaches the two contacts from any direction, the two contacts are brought into contact and closed through the universal touch control structure.

In the present embodiment, the universal touch control structure includes an active contact 4 and a ring contact 5. The ring contact can be of any shape with a closed ring structure. In the present embodiment, the active contact is spherical, but it can also be cylindrical or of any other shape. One end of the active contact 4 is connected to the first lead 3, and one end of the ring contact 5 is connected to the second lead 2. In actual use, the one end of the active contact 4 can also be connected to the second lead 2, and the one end of the ring contact 5 connected to the first lead 3.

As shown in FIG. 3, the active contact 4 and the ring contact 5 are arranged in a sealed housing 1, which is filled with inert gas or vacuum.

The ring contact 5 has a contact chamber that accommodates the active contact 4. The active contact 4 is arranged in the contact chamber, and the active contact 4 and the ring contact 5 are normally open. When the external magnet approaches, the active contact 4 and the ring contact 5 are brought into contact and closed. In the present embodiment, the ring contact is in the form of a hemispherical bearing structure, but it can be of other ring structures that allow the active contact to be engaged in any direction.

In the present embodiment, since the active contact and the ring contact can close from any direction the magnet approaches, the present disclosure effectively solves the reed switch failure problem.

The above is only a specific embodiment of the present disclosure, but the scope of protection is not limited herein. Any changes or substitutions that can be thought of without creative labor should be encompassed within the scope of protection of the present disclosure. Therefore, the scope of protection of the present disclosure should be defined by the claims.

1. A universal touch control reed switch, comprising a first lead (3), a second lead (2), and contacts respectively arranged on the first lead (3) and the second lead (2), wherein the contacts are conducted in a touch control mode by using a universal touch control structure, and wherein, when an external magnet approaches the two contacts in any direction, the two contacts are in contact with each other and closed in any direction through the universal touch control structure.

2. The universal touch control reed switch according to claim 1, wherein the universal touch control structure includes an active contact (4) and a ring contact (5), wherein one end of the active contact (4) is connected to the first lead (3) and one end of the ring contact (5) is connected to the second lead (2), or the one end of the active contact (4) is connected to the second lead (2) and the one end of the ring contact (5) is connected to the first lead (3).

3. The universal touch control reed switch according claim 2, wherein the active contact (4) and the ring contact (5) are correspondingly arranged in a sealed housing (1) and the sealed housing (1) is filled with inert gas or vacuum.

4. The universal touch control reed switch according claim 2, wherein the ring contact (5) has a contact chamber that accommodates the active contact (4), the active contact (4) is arranged in the contact chamber, and the active contact (4) and the ring contact (5) are in a normally open state, and wherein, when the external magnet approaches, the active contact (4) and the ring contact (5) are in contact with each other and closed.

5. The universal touch control reed switch according claim 3, wherein the ring contact (5) has a contact chamber that accommodates the active contact (4), the active contact (4) is arranged in the contact chamber, and the active contact (4) and the ring contact (5) are in a normally open state, and wherein, when the external magnet approaches, the active contact (4) and the ring contact (5) are in contact with each other and closed.
